(19) United States
(12) Patent Application Publication
(10) Pub. No.: US 2011/0193455 A1
(43) Pub. Date: Aug. 11, 2011

(54) Fitting for a Corner Cabinet

(75) Inventors: Reiner Kreyenkamp, Bad Essen (DE); Dietmar Baro, Osnabruck (DE); Frank Martling, Bad Essen (DE)

(73) Assignee: HEINRICH J. KESSEBÖHMER KG, Bad Essen (DE)

(21) Appl. No.: 13/021,719

(22) Filed: Feb. 5, 2011

(30) Foreign Application Priority Data
Feb. 5, 2010 (DE) 10 2010 007 129.3

(51) Int. Cl. A47B 77/00; A47B 96/02; E05F 5/02

(52) U.S. Cl. 312/238; 16/82

(57) ABSTRACT

A fitting for a corner cabinet accessible through a door has a support arranged stationarily in the interior of the corner cabinet for securing a shelf. The support has a guide member supporting the shelf and moving the shelf on a predetermined movement path from an inner position inside the cabinet into an outer position in front of a door opening of the corner cabinet. The guide member is pivotably connected to a bottom side of the shelf and pivotably connected to a corner cabinet wall. A pull-in device is operatively connected to the shelf and the guide member and automatically pulls in by an automatic pull-in action the shelf into the interior during a closing movement from the outer position into the innerposition. The automatic pull-in action begins at a predeterminable intermediate pivot position of the shelf during the closing movement.

### BACKGROUND OF THE INVENTION

The invention relates to a fitting for a corner cabinet, in particular for a corner cabinet of a kitchen, comprising an interior of a substantially rectangular footprint that is accessible at the front by means of a corner cabinet door. The fitting comprises at least one support that is supportable within the interior of the corner cabinet for securing at least one one-piece shelf of a substantially semi-circular basic shape wherein the support comprises at least one guide member that supports the shelf and moves the shelf on a predetermined movement path from an inner position inside the interior of the corner cabinet into an outer position outside of the corner cabinet where the shelf is substantially in front of the door opening of the corner cabinet. The guide member is pivotably connected to the bottom side of the shelf and, by means of a support fitting, is pivotably connected to a corner cabinet part, in particular a sidewall part.

A fitting for corner cabinets of the aforementioned kind is disclosed in US 2006/0012273 A1. In this fitting, the support comprises two guide members that control the predetermined movement path of the shelf wherein one of the guide members is supported in a pivotable way on a stationary support column in the interior of the corner cabinet and the other guide member is supported on the sidewall of the corner cabinet. The two guide members are connected pivotably to the bottom side of each shelf so that they ensure that the shelf is movably supported such that not only a pivot movement about one axis is carried out but that the shelf also carries out an additional movement relative to a circular movement path, which makes it possible that, as a result of the movement path controlled by these two guide members, the shelf assumes an end position in which the shelf is substantially positioned in front of the door opening of the corner cabinet.

It is particularly advantageous in this connection that, even when several shelves are positioned at a spacing above each other, the shelves can also be pivoted individually into the outward position without all the other shelves that are provided having to be moved also mandatorily by having individual guide members correlated with each shelf. Each shelf surface area is therefore accessible individually from above by the user.

EP 1 776 899 B1 discloses a pivotable shelf arrangement for a corner cabinet that, in analogy to the fitting disclosed in the above mentioned document, operates with two guide members, one being connected to the sidewall of the corner cabinet and the other to a vertical support column. As a result of the two provided guide members, in this system a shelf is also movable into a position that is substantially in front of the door opening. As a result of a construction with support arm-like feature, two shelves that are arranged atop each other can however only be moved together into a position in front of the door opening so that the shelf positioned underneath the top shelf is not easily or freely accessible from above.

The fittings disclosed in these two documents each have shelves that, as a result of the movement path controlled by the guide members, are to be moved into an end position in which the shelves are substantially positioned in front of the door opening of the corner cabinet, a large pivoting closure movement must be carried out for returning the shelves to the inner position. In practical operation, this often entails that the shelves are returned into the cabinet by a forceful movement caused by the operator which may result in the objects that are supported by the shelves tipping over and then impairing free movability of the shelves in a subsequent opening movement.

### SUMMARY OF THE INVENTION

It is an object of the present invention to further develop a fitting for corner cabinets of the aforementioned kind in such a way that, while maintaining the advantageous support of a shelf by means of a guide member and the possibility of positioning the shelves substantially in front of the door opening in their end position, it is possible to carry out the closing movement in a controlled fashion.

In accordance with the present invention, this is achieved in that the shelf and its guide member have correlated therewith a pull-in device (self-closing device) for automatically pulling in the shelf and the guide member into the interior of the corner cabinet which automatic pull-in action begins at a predeterminable intermediate pivot position of the shelf during the course of its closing movement from the outer end position into the inner end position.

In this way, a fitting for corner cabinets is provided that enables that a shelf can be transferred in a controlled fashion and in accordance with the adjustments of the pull-in (self-closing) device into the inner end position (closed position). An accidental forceful pivoting action of the shelf caused by manually applied force application is possible only for an initial closing movement. Beginning with the preselected intermediate pivot position, the pull-in (self-closing) device will become active and, particularly when configured also as a damping means, will dampen the final portion of the closing movement and will carry out the further closing action of the shelf automatically.

It is preferred that, as disclosed in the aforementioned US 2006/0012273 A1, two guide members are provided which, however, according to the fitting of the present invention, engage on a first sidewall that is positioned near or proximal to the door opening and a second sidewall that is spaced from the first sidewall but is also proximal to the door opening. In this way, a controlled movement path results but a vertical support column is no longer needed. Advantageously, the arrangement is such that the pull-in (self-closing) device interacts with only one of the two guide members and engages pivotably this guide member. Preferably, for this purpose a guide rail is provided that is pivotably connected to the shelf and is provided with a guide path that is matched such to the closing movement of the shelf caused by the guide member that the pull-in (self-dosing) device, during the course of the closing movement, first will exert no force onto the shelf but, beginning at the certain intermediate pivot position, will exert a closing force onto the guide member and by means of the guide member onto the shelf.

For this purpose, the guide path has preferably an arc-shaped first section that, for example, passes into a straight second section of the guide path. The curved or arc-shaped first section is matched to the pivot movement and the circular segments of the movement of the guide member and the guide elements connected thereto so that the resulting force on the guide path, which force is aligned orthogonally to the respective guide point of the guide path, is first positioned on the straight connecting line between the vertical axis of the guide element of the guide member and the pivot axis of the guide member on the shelf so that no leverage for generating a closing movement can be produced. Only beginning with the predetermined intermediate position, the guide path is designed such that the orthogonally oriented resulting closing force with advancing closing movement, beginning with the predetermined intermediate pivot position, will exert a closing moment onto the guide member and thus onto the shelf.

Moreover, it may also be provided that the shelf is provided with a follower device for the door of the corner cabinet. This can be realized in such a way that, from a certain position on, the door is coupled automatically to the shelf by means of a suitable coupling so that the pull-in (self-closing) device transfers the shelf, the guide member(s) as well as the door automatically into their closed position.

### BRIEF DESCRIPTION OF THE DRAWING

FIG. 1 is a schematic plan view of an embodiment of a corner cabinet with an embodiment of a fitting according to the invention in the open position of a shelf.

FIG. 1.1 shows the detail 1.1 of FIG. 1.

FIG. 2 is an illustration in analogy to FIG. 1 of the illustrated embodiment at the beginning of the closing movement where the pull-in device is not yet active.

FIG. 2.1 shows the detail 2.1 of FIG. 2.

FIG. 3 is an illustration in analogy to FIGS. 1 and 2 illustrating the shelf in the intermediate pivot position in which the pull-in (self-closing) device begins to act.

FIG. 3.1 shows the detail 3.1 of FIG. 3.

FIG. 4 is an illustration in analogy to FIGS. 1, 2, and 3 with illustration of the position of the shelf in the inner end position (closed position).

FIG. 4.1 shows the detail 4.1 of FIG. 4

### DESCRIPTION OF THE PREFERRED EMBODIMENTS

The components that are the same in the drawings are generally identified with identical reference numerals.

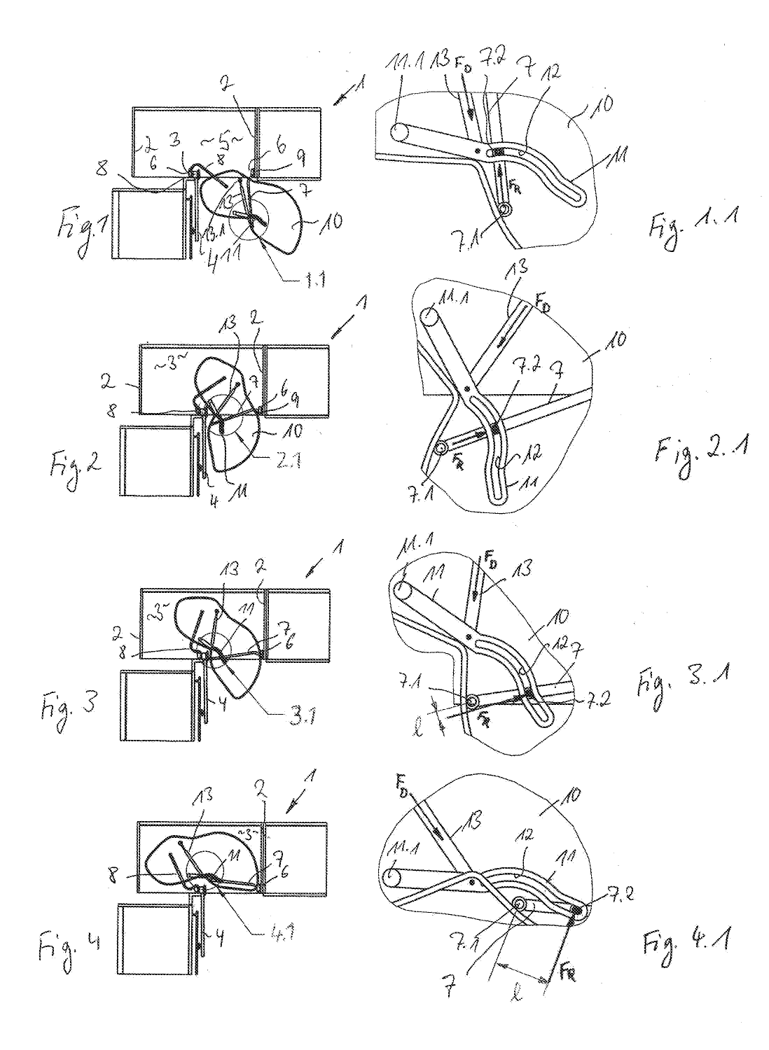

Reference numeral 1 identifies in the drawings a corner cabinet with sidewalls 2, a door post 5 as well as a door 4 and an interior 3. A support is provided that is comprised of the guide member 7 and the guide member 8 as well as securing devices 9, not illustrated in detail. The stationary support supports a shelf 10 within the interior 3. The shelf 10 can be transferred from an inner position, illustrated in FIG. 4, into an open outer position according to FIG. 1 in which the shelf 10 is substantially completely positioned in front of the door opening of the corner cabinet.

The guide members 7 and 8 are preferably height-adjustably supported on the securing devices 9, for example in that the securing device 9 has keyhole-shaped cutouts that are engaged by fastening projections of the mountings 6 of the guide members 7 and 8, depending on the desired space conditions.

As illustrated in detail in FIGS. 1.1, 2.1, 3.1, and 4.1, at the bottom side of the shelf 10 not only the guide member 7 is pivotably connected at 7.1 (pivot axis); guide rail 11 is also provided thereat which is pivotably connected (pivot axis 11.1) to the bottom side of the shelf 10. The guide rail 11 has a guide path 12 that is engaged by a guide element 7.2 of the guide member 7. This guide path 12 has initially an arc-shaped section and then passes into a straight section. Moreover, a pull-in (self-closing) device) 3 engages the guide rail 11 that, as illustrated in FIGS. 1, 2, 3, and 4, is also pivotably connected to the bottom side of the shelf 11 at 13.1. This pull-in (self-closing) device 13 forms also a damping means. In the illustrated embodiment, it is embodied a gas pressure spring.

The guide path 12, the position of the guide element 7.2 of the guide member 7, and the pivot movements of the guide rail 11, on the one hand, and of the guide member 7, on the other hand, are matched to one another such that initially at the beginning of a closing movement, as illustrated in FIGS. 1 and 2, the pull-in device 13 will not be active yet. This is apparent from the fact that the force direction of the force vector F_{R} as a resulting force of the action (F_{D}) of the pull-in device 13 has no angular arm relative to the vertical longitudinal center axis (axis perpendicular to the plane of the shelf 10) of the guide element 7.2 because the force F_{R} acting orthogonally onto the guide path 12 intersects this vertical longitudinal center axis of the guide element 7.2 so that there is no lever action for generating a closing moment.

Beginning with the preselected intermediate pivot position, illustrated in FIG. 3, where the guide element 7.2 has already passed the arc-shaped section of the guide path 12 as a result of the pivot movements of the involved parts, the guide element 7.2 is now located in the straight section of the guide path 12. The closing force F_{R} generated by the pull-in device 13 and oriented orthogonally to the guide path has thus a spacing I relative to the vertical pivot axis 7.1 of the guide member 7 at the bottom side of the shelf 10. Thus, the pull-in device 13 generates the closing moment defined by F_{R}×I.

This closing moment during the course of the further closing movement of the shelf 10 becomes larger and in the end position, illustrated in FIG. 4, has the greatest value. In this position, the guide element 7.2 is at the end of the guide path 12 so that the leverage I illustrated in FIG. 4.1 results; this means that the greatest closing moment now exists and at the same time damping action for the shelf is provided. Not illustrated in detail, a coupling maybe provided on the shelf for entraining the door 4 of the corner cabinet.

The specification incorporates by reference the entire disclosure of German priority document 10 2010 007 129.3 having a filing date of Feb. 5, 2010.

While specific embodiments of the invention have been shown and described in detail to illustrate the inventive principles, it will be understood that the invention may be embodied otherwise without departing from such principles.

What is claimed is:

1. A fitting for a corner cabinet that has an interior of substantially rectangular footprint and is accessible through a door at a front of the corner cabinet, the fitting comprising:
at least one support adapted to be arranged stationarily in an interior of the corner cabinet for securing at least one one-piece shelf of a substantially semi-circular basic shape;
wherein the at least support comprises at least one guide member supporting the shelf and moving the shelf on a predetermined movement path from an inner position inside the interior of the corner cabinet into an outer position outside of the corner cabinet substantially in front of a door opening of the corner cabinet;
wherein the at least one guide member is pivotably connected to a bottom side of the shelf to pivot about a pivot axis and pivotably connected to a part of the corner cabinet;
a pull-in device operatively connected to the shelf and the at least one guide member, wherein the pull-in device automatically pulls in by an automatic pull-in action the shelf into the interior of the corner cabinet during a closing movement from the outer position into the inner position, wherein the automatic pull-in action begins at a predeterminable intermediate pivot position of the shelf during the closing movement.

2. The fitting for a corner cabinet according to claim 1, wherein the pull-in device comprises a damping means that provides a damping action for a final portion of the closing movement of the shelf.

3. The fitting for a corner cabinet according to claim 1, comprising a coupling connected to the shelf, wherein the coupling is adapted to couple a door of the corner cabinet such that the door, coupled to the shelf, is transferred automatically by the pull-in device into a closed position.

4. The fitting for a corner cabinet according to claim 1, comprising a guide rail pivotably connected to the shelf and interacting with the at least one guide member, wherein the pull-in device has a first end and a second end, wherein the first end is connected pivotably to a bottom side of the shelf and the second end engages the guide rail.

5. The fitting for a corner cabinet according to claim 4, wherein the guide rail has a guide path with a first section that is arc-shaped and a second section adjoining the first section and being straight or arc-shaped, wherein the at least one guide member has a guide element that engages the guide rail, and wherein the pull-in device engages the guide rail.

6. The fitting for a corner cabinet according to claim 5, wherein a pivot movement path of the guide rail, a position of a pivot axis of the at least one guide rail, and the first section of the guide path are matched relative to one another such that an orthogonal line relative to the guide path that is intersecting a vertical longitudinal center axis of the guide element of the at least one guide member is positioned on a straight connecting line between the vertical longitudinal center axis of the guide element and the pivot axis of the at least one guide member, wherein the orthogonal line, beginning at the intermediate pivot position in which the pull-in device begins to act, moves away from the first pivot axis of the at least one guide member during the closing movement of the shelf.

7. The fitting for a corner cabinet according to claim 1, wherein the pull-in device is embodied as a gas pressure spring.

8. The fitting for a corner cabinet according to claim 1, wherein the support comprises two of the at least one guide member and wherein the shelf together with the pull-in device is attachable by the two guide members to securing devices of the support so as to be height-adjustable, wherein the securing devices are attached to sidewalls of the corner cabinet.

9. The fitting for a corner cabinet according to claim 1, wherein the support comprises two of the at least one guide member connected to the shelf, wherein a first one of the two guide members is connected to a first wall of the corner cabinet proximal to the door opening so as to be pivotable about a first vertical axis and a second one of the two guide members is connected to a second wall of the corner cabinet proximal to the door opening so as to be pivotable about a second vertical axis, wherein the first and second vertical axes are spaced apart horizontally, wherein the pull-in device is operatively connected to only one of the two guide members.
